(19) United States
(12) Patent Application Publication
(10) Pub. No.: US 2005/0089384 A1
(43) Pub. Date: Apr. 28, 2005

(54) FASTENER WITH ADHESIVE

(76) Inventor: Adam D. Pratt, Buffalo, NY (US)

Correspondence Address: SIMPSON & SIMPSON, PLLC, 5555 MAIN STREET, WILLIAMSVILLE, NY, 14221-5406, US

(21) Appl. No.: 10/605,729

(22) Filed: Oct. 22, 2003

(51) Int. Cl. F16B 39/02

(52) U.S. Cl. 411/82

(57) ABSTRACT

A fastener comprising an inner surface and an outer surface is disclosed. The outer surface has an adhesive thereon.

### FIELD OF THE INVENTION

This invention relates to fasteners. More specifically it relates to a fastener comprising an adhesive.

### BACKGROUND OF THE INVENTION

The problem of efficiently and reliably fastening two members together has been a problem in the construction of objects such as buildings, vehicles, and machines. Rivets were developed as one solution to this problem. In response to a desire to provide an additional fastening means to a rivet, the blind rivet nut was developed. A blind rivet nut typically comprises a threaded aperture, which a screw can be anchored in after the blind rivet nut is fastened to a surface, such as disclosed by U.S. Pat. No. 2,149,199 (Waner). However, one problem with a blind rivet nut is it may spin with respect to the surface when the screw is driven into the hole.

Several approaches have been taken to prevent the blind rivet nut from spinning with respect to the surface. One approach is to fabricate the blind rivet nut with a hexagonal cross-section for the outer surface. The blind rivet nut is then fastened in a hexagonal hole. This is undesirable because it requires boring a hexagonal hole. Hexagonal shaped blind rivet nuts may still spin with respect to the surface they are mounted in if sufficient torque is applied to the blind rivet nut through the screw mounted therein.

A second approach is to provide ridges on the outer surface, or a knurled outer surface. These non-smooth surfaces create additional friction between the edge of the aperture and the blind rivet nut. While these blind rivet nuts require more torque to spin than smooth blind rivet nuts, they are still insufficient for some high torque applications.

Clearly, then, there is a long felt need for a fastener that is more resistant to spinning with respect to the surface the fastener is mounted within.

### SUMMARY OF THE INVENTION

The present invention broadly comprises a fastener. The fastener comprises an inner surface and an outer surface.

The outer surface has an adhesive thereon.

A general object of the present invention is to provide a fastener having an adhesive on an outer surface.

These and other objects, features and advantages of the present invention will become readily apparent to those having ordinary skill in the art upon a reading of the following detailed description of the invention in view of the drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a rear perspective view of a first embodiment of the present invention;

FIG. 2 is a front perspective view of a first embodiment of the present invention;

FIG. 3 is a rear perspective view of a second embodiment of the present invention;

FIG. 4 is a front perspective view of a second embodiment of the present invention;

FIG. 5 is a rear perspective view of a third embodiment of the present invention;

FIG. 6 is a front perspective view of a third embodiment of the present invention;

FIG. 7 is a rear perspective view of a fourth embodiment of the present invention;

FIG. 8 is a front perspective view of a fourth embodiment of the present invention;

FIG. 9 is a rear perspective view of a fifth embodiment of the present invention;

FIG. 10 is a front perspective view of a fifth embodiment of the present invention;

FIG. 11 is a side view of a sixth embodiment of the present invention;

FIG. 12 is a side view of a sixth embodiment of the present invention after installation;

FIG. 13 is a side view of a seventh embodiment of the present invention;

FIG. 14 is a side view of a seventh embodiment of the present invention being installed with an installation tool;

FIG. 15 is a side cutaway view of a first embodiment of the present invention taken along line 15-15 of FIG. 1, showing a fastening tool engaged with the present invention;

FIG. 16 is a side cutaway view of a first embodiment of the present invention fastening two members together; and,

FIG. 17 is a view of a fastener engaged with the present invention.

### DETAILED DESCRIPTION OF THE PREFERRED EMBODIMENT

It should be appreciated that, in the detailed description of the invention that follows, like reference numbers on different drawing views are intended to identify identical structural elements of the invention in the respective views. In the present specification, the term fastener is used in describing the present invention. It should be readily apparent to one skilled in the art that the fasteners of the present invention may include such fasteners known in the art as rivet nuts, RIVNUTS®, threaded inserts, blind threaded inserts, threaded studs, and blind threaded studs. These fasteners and others may be used in practicing the present invention.

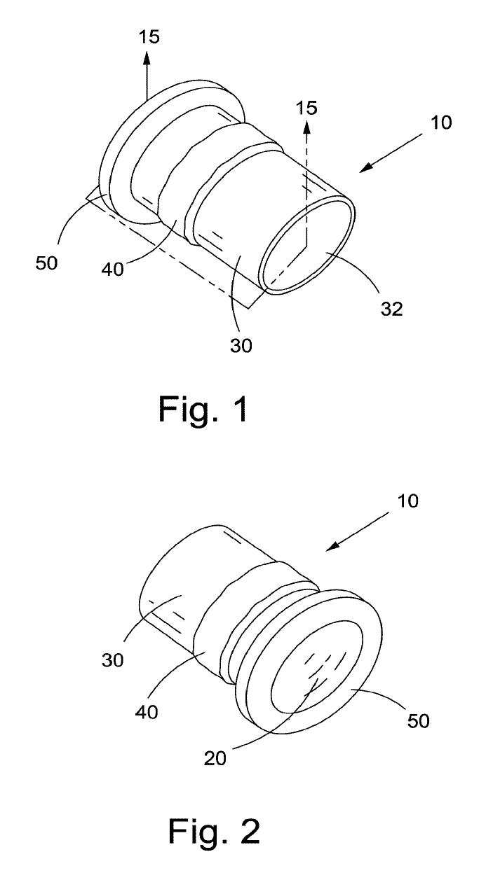

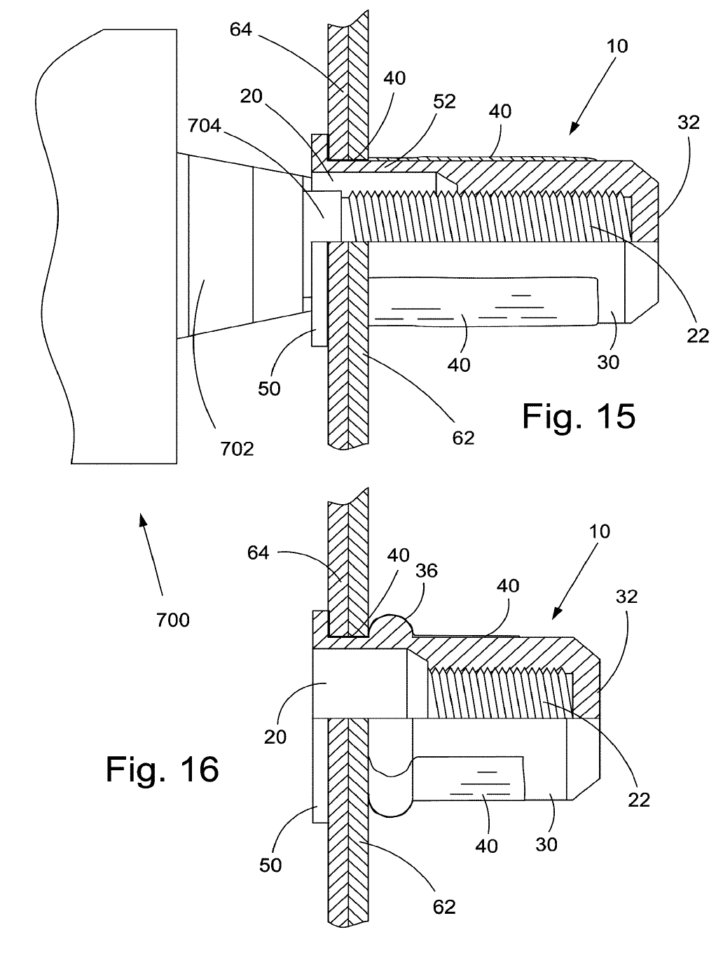

A first embodiment of the present invention is illustrated in FIG. 1 and designated 10. Fastener 10 comprises an inner surface 20 and an outer surface 30. Inner surface 20 comprises a threaded portion 22 (shown in the cutaway views of FIGS. 15 and 16). Outer surface 30 comprises adhesive 40. In the embodiment shown in FIGS. 1 and 2, fastener 10 further comprises a flange 50. Flange 50 aligns the fastener with the front surface of the member being fastened, when the fastener is inserted in an aperture in the member (also shown in FIGS. 15 and 16). It should be readily apparent to one skilled in the art that fasteners that do not comprise a flange are possible, and fasteners without flanges are within the spirit and scope of the invention as claimed.

Fastener 10 further comprises a closed end 32, shown in FIG. 1. As shown in FIGS. 1 and 2, outer surface 30 is substantially smooth. FIGS. 1 and 2 further show a ring of adhesive around the circumference of the outer surface. Fastener 10 has a circular cross section.

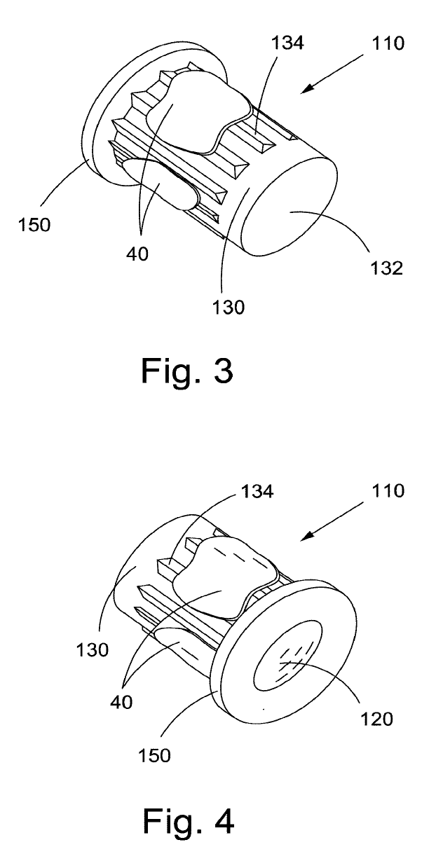

In a second embodiment, shown in FIGS. 3 and 4 and designated 110, outer surface 30 also comprises ridges 134. The ridges extend to the rear surface of flange 150. Adhesive 40 is located in patches on outer surface 30, covering a portion of ridges 134. Fastener 110 also comprises inner surface 120 and closed end 132. Fastener 110 has a circular cross section.

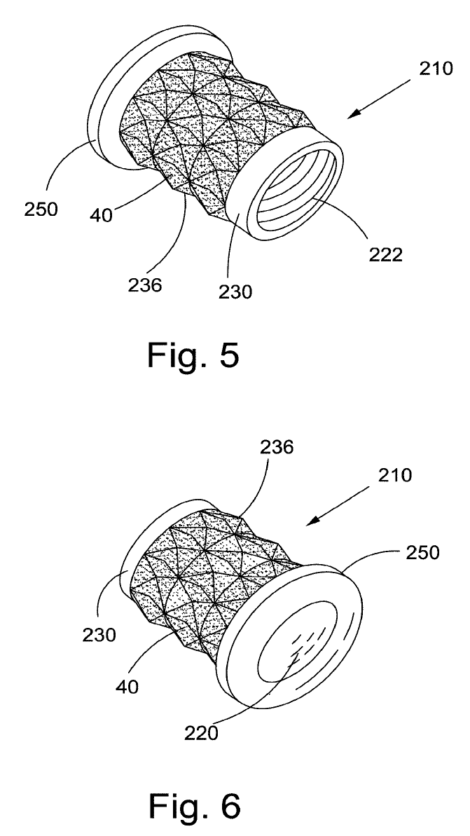

FIGS. 5 and 6 illustrate a third embodiment, designated 210. The outer surface 230 of fastener 210 comprises knurled surface 236. Surface 236 is covered by adhesive 40. It should be readily apparent to one skilled in the art that portions of the outer surface may be ridged, knurled, smooth, or any other texture known in the art, and these modifications are within the spirit and scope of the invention as claimed. Further, any part of the outer surface may be textured, such as a potion of the rear surface of flange 250.

Fastener 210 does not have a closed end. Instead, threaded portion 222 of inner surface 220 is visible in FIG. 5 through the open end of fastener 210. Fasteners with open ends or with closed ends are within the spirit and scope of the invention as claimed. Fastener 210 also comprises flange 250. Fastener 210 has a circular cross section.

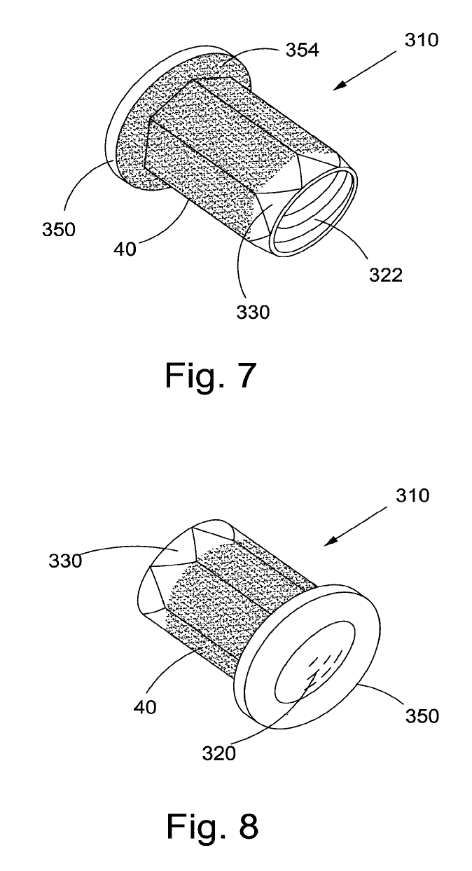

A fourth embodiment, designated 310, is illustrated in FIGS. 7 and 8. FIGS. 7 and 8 show a fastener with adhesive 40 substantially covering outer surface 330. The outer surface 330 of fastener 310 has a hexagonal cross section. It should be readily apparent to one skilled in the art that the present invention may comprise fasteners having circular cross sections, hexagonal cross sections, or any other cross section known in the art. These modifications are intended to be within the spirit and scope of the invention as claimed. For example, a variety of fasteners known in the art are available from Sherex Industries, Inc., 1400 Commerce Parkway, Lancaster, N.Y. 14086 (www.sherex.com). Fastener 310 also comprises inner surface 320, threaded surface 322, and flange 350.

As shown in FIG. 7, adhesive 40 is located on rear surface 354 of flange 350. Rear surface 354 may be partially or completely covered with adhesive in an embodiment of the present invention. Fasteners having adhesive on a portion of a rear surface of a flange are within the spirit and scope of the invention as claimed.

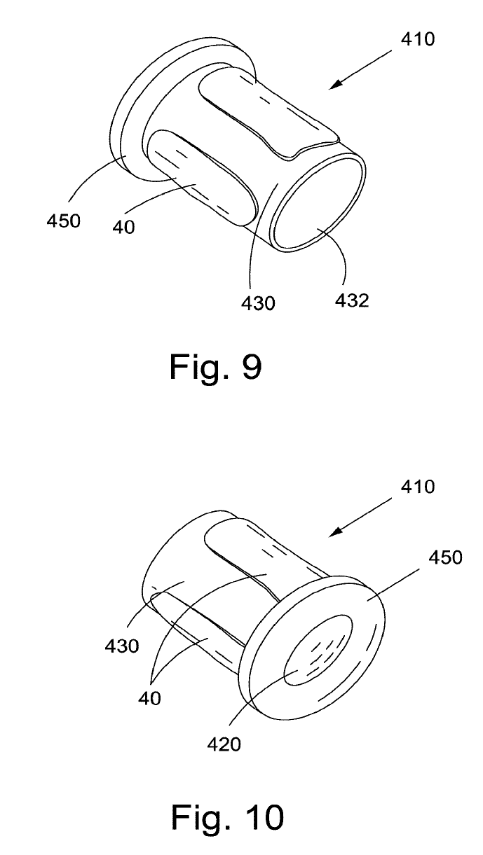

FIGS. 9 and 10 illustrate a fifth embodiment, designated 410. Fastener 410 comprises patches of adhesive 40 on outer surface 430. It should be readily apparent to one skilled in the art that any configuration of adhesive on the outer surface is possible, and these modifications are within the spirit and scope of the invention as claimed. Fastener 410 also comprises inner surface 420, closed end 432, and flange 450.

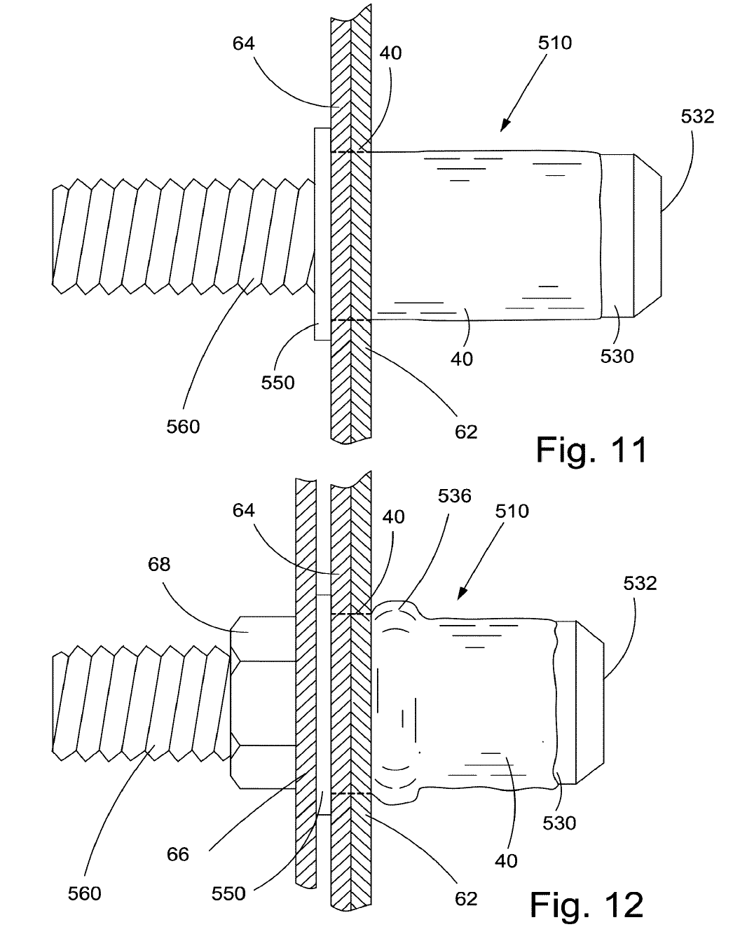

FIGS. 11 and 12 illustrate a sixth embodiment, designated 510. Fastener 510 comprises stud 560. Fastener 510 further comprises adhesive 40 on outer surface 530. Fastener 510 is placed in an aperture in surfaces 62 and 64. The stud is turned using a hand or pneumatic tool as is known in the art (available, for example, through AVK Industrial Products, a division of Avibank Mfg., Inc. located in Burbank, Calif.). Turning the stud causes a portion of the fastener to buckle, forming bulge 536, as shown in FIG. 12. It should be readily apparent to one skilled in the art that fasteners with or without a stud are possible, and these modifications are within the spirit and scope of the invention as claimed. Fastener 510 also comprises closed end 532 and flange 550. Stud 560 allows nut 68 to be threaded thereon after installation. Thus, surface 66 may be secured to surfaces 62 and 64 using fastener 510 and nut 68.

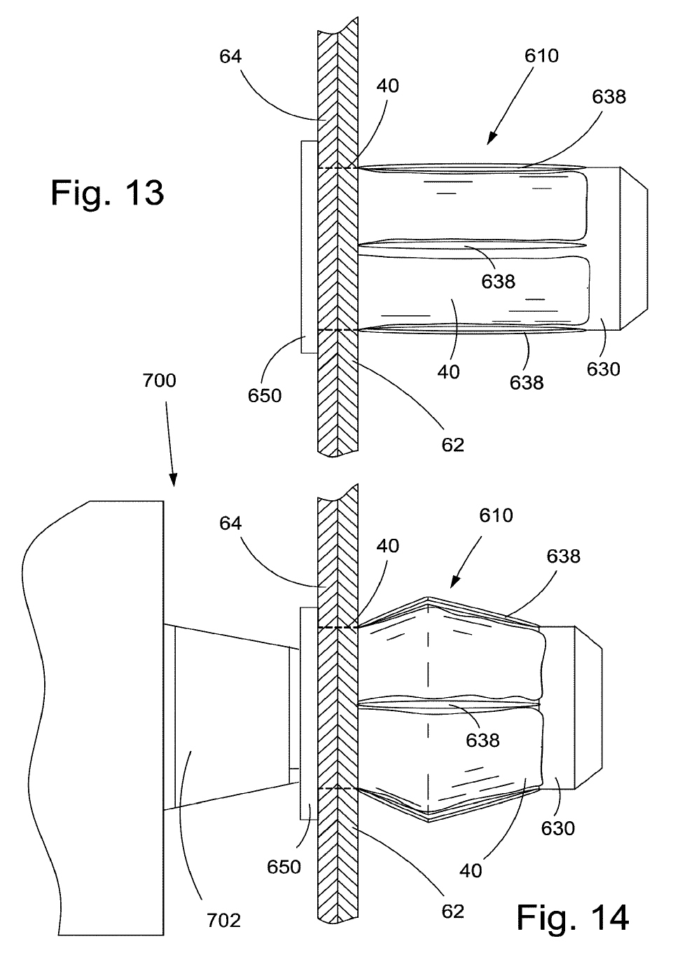

FIGS. 13 and 14 illustrate a seventh embodiment, designated 610. Fastener 610 comprises patches of adhesive 40 on outer surface 630. Fastener 610 further comprises slots 638 in outer surface 630. To join surface 62 and 64, fastener 630 is inserted in an aperture in each surface. Mandrel 704 (shown in FIG. 15) of fastening tool 700 is inserted in the fastener. The mandrel is rotated to draw the fastener towards tool 700. It should be readily apparent to one skilled in the art that fasteners with or without slots are possible, and these modifications are within the spirit and scope of the invention as claimed. Fastener 610 also comprises flange 650.

The present invention is used as shown in FIGS. 15 and 16. A portion of fastener installation tool 700 is shown engaging the threaded portion 22 of inner surface 20 of fastener 10. Mandrel 704 is secured in anvil 702 of installation tool 700. The fastener installation tool may be any such tool known in the art, such as hand tools (for example, the MS 7 Titgemeyer or the MS 480 Masterfix), pneumatic tools (for example, the SSG-801, the SSG-802, the SSG-803, or the SSG-808), or hydro-pneumatic tools (for example, the MS 50 or the MS 100). All of the above tools are available from Sherex Industries, Inc., 1400 Commerce Parkway, Lancaster, N.Y. 14086 (“www.sherex.com). To fasten members 62 and 64 together, mandrel 704 is rotated, drawing the fastener towards tool 700. Thin wall 52 buckles in response to the force exerted by the mandrel, forming bulge 36. Bulge 36 abuts the rear surface of surface of member 62, locking it in place adjacent to member 64, as shown in FIG. 16.

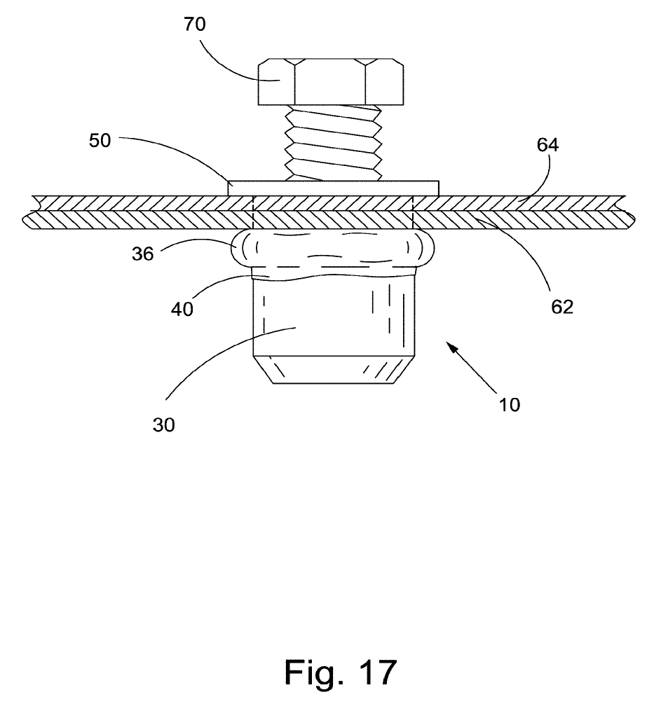

FIG. 17 shows the present invention securing together members 62 and 64, and screw 70 engaged with the threaded inner surface 22.

FIGS. 1-17 show adhesive 40 located on a variety of fasteners. The fasteners may be fabricated of metal, stainless steel, aluminum, or any other material known in the art. They may be fabricated by machining, cold forming, or any other method known in the art. Adhesive 40 may be any adhesive known in the art suitable for connecting a fastener to a surface (the surface may comprise, for example, metal, plastic, or wood). For example, adhesive 40 may be a polymer dissolved in a solvent, or an epoxy. Cyanocrylate, hotmelt, liquid, epoxy, anaerobic, and aerosol adhesives may all be used in practicing the present invention. In one embodiment, a threadlocking compound comprising a methacrylate ester is used. In another embodiment, a threadlocking compound comprising an epoxy is used. Further, the adhesive of the present invention may be enclosed in microcapsules that burst when the fastener is mounted in the aperture. Encapsulated adhesives are disclosed in U.S. Pat. No. 3,293,977 (Dalton et al.), incorporated herein by reference.

Thus, it is seen that the objects of the present invention are efficiently obtained, although modifications and changes to the invention should be readily apparent to those having ordinary skill in the art, and these modifications are intended to be within the spirit and scope of the invention as claimed.

1. An article for fastening comprising:
a fastener selected from the group including a rivet nut, a rivet nut stud, a threaded insert, and a blind threaded insert, wherein said fastener has an inner surface and an outer surface; and at least a portion of said outer surface has an adhesive thereon.

2. The article recited in claim 1 wherein said adhesive layer forms a strip around said outer surface.

3. The article recited in claim 1 wherein said adhesive layer covers said outer surface.

4. The article recited in claim 1 wherein said fastener has a substantially circular cross-section.

5. The article recited in claim 1 wherein said fastener has a hexagonal cross-section.

6. The article recited in claim 1 wherein said outer surface further comprises at least one ridge.

7. The article recited in claim 6 wherein said adhesive layer is located on said at least one ridge.

8. The article recited in claim 7 wherein said adhesive layer covers said at least one ridge.

9. The article recited in claim 1 wherein said outer surface further comprises a knurled portion.

10. The article recited in claim 9 wherein said adhesive layer is located on said knurled portion of said outer surface.

11. The article recited in claim 10 wherein said adhesive layer covers said knurled portion.

12. The article recited in claim 1 wherein said adhesive layer comprises a threadlocking composition.

13. The article recited in claim 12 wherein said threadlocking composition comprises methacrylate ester.

14. The article recited in claim 12 wherein said threadlocking composition comprises an epoxy.

15. The article recited in claim 1 wherein a portion of said inner surface is threaded.

16. The article recited in claim 1 further comprising a flange with a surface.

17. The article recited in claim 16 wherein a portion of said surface of said flange has adhesive thereon.

18. The article recited in claim 16 wherein said flange comprises a knurled portion.

19. The article recited in claim 18 wherein said knurled portion of said flange has adhesive thereon.

20. The article recited in claim 1 further comprising a stud.

21. The article recited in claim 1 wherein said outer surface comprises at least one slot.

22. The article recited in claim 1 wherein said adhesive is enclosed in microcapsules.

23. The article recited in claim 1 wherein said fastener has a closed end.

24. The article recited in claim 1 wherein said fastener has an open end.

25. An article for fastening comprising:
a fastener selected from the group including a rivet nut, a rivet nut stud, a threaded insert, and a blind threaded insert, wherein said fastener has an inner surface, an outer surface, and a flange and at least a portion of a surface of said flange has an adhesive thereon.
